(19) United States
(12) Patent Application Publication
(10) Pub. No.: US 2016/0234425 A1
(43) Pub. Date: Aug. 11, 2016

(54) IMAGE PROCESSING APPARATUS

(71) Applicant: CANON KABUSHIKI KAISHA, Tokyo (JP)

(72) Inventor: Hiroyasu Katagawa, Yokohama-shi (JP)

(21) Appl. No.: 15/014,362

(22) Filed: Feb. 3, 2016

(30) Foreign Application Priority Data
Feb. 5, 2015 (JP) 2015-021317

(51) Int. Cl. H04N 5/232; G02B 7/34; H04N 5/369

(52) U.S. Cl. CPC H04N 5/23212; H04N 5/3696; G02B 7/34

(57) ABSTRACT

Provided is an image processing apparatus, including: pixel portions each configured to output a first added signal obtained by adding signals output from a first group among a plurality of photoelectric converters and output a second added signal obtained by adding signals output from a second group, which is a part of the first group; an added signal separation unit configured to generate a third added signal by subtracting the second added signal from the first added signal, and output the second and the third added signal; a phase difference measurement unit configured to perform a phase difference measurement based on the second and the third added signal; and an image pickup element drive unit configured to change a combination of photoelectric converters included in the second group so as to change a pupil division direction for the phase difference measurement performed in the phase difference measurement unit.

### BACKGROUND OF THE INVENTION

1. Field of the Invention

The present invention relates to an image processing apparatus.

2. Description of the Related Art

There is known an autofocus (AF) technology for obtaining pupil-divided images by an image pickup element having a plurality of photoelectric converters arranged therein for one microlens and detecting a focus based on a phase difference between the plurality of obtained pupil-divided images.

For example, in Japanese Patent Application Laid-Open No. 2001-83407, there is disclosed a configuration for treating a plurality of photoelectric converters as one photoelectric converter by adding all the signals from photoelectric converters sharing a single microlens as well as detecting a focus based on a phase difference between pupil-divided images. With this, it is possible to treat the signal in the same way as in the case of one photoelectric converter, and an image for viewing may be created by a signal processing technology.

However, in the configuration of the above-mentioned related art, processing of adding obtained signals for generation is necessary to generate an image signal. For example, when four photoelectric converters share one microlens, the number of signals to be read out from an image pickup element is four times the number of microlenses in order to obtain a desired image signal. In other words, the number of signals to be read out is proportional to the number of photoelectric converters in one microlens, and hence a processing load may be high in a system such as a digital camera or a digital video camera where the image signal is read out every predetermined time period.

As a solution to the above-mentioned problem, it is conceivable to reduce the number of signals to be read out by adding signals from the photoelectric converters within the image pickup element for a direction other than the pupil division direction. However, also in this case, compared to a read-out scheme for an image pickup element array where pupils are not divided, the number of signals to be read out is twice in a phase difference focus detection for detecting a focus by calculating a phase difference between two pupil-divided images, and hence the processing load may similarly be high.

### SUMMARY OF THE INVENTION

According to one embodiment of the present invention, there is provided an image processing apparatus, including: an image pickup element including pixel portions, the pixel portions each including a plurality of photoelectric converters and each being configured to output a first added signal obtained by adding signals output from a first group among the plurality of photoelectric converters and output a second added signal obtained by adding signals output from a second group, which is a part of the first group among the plurality of photoelectric converters; an added signal separation unit configured to generate a third added signal by subtracting the second added signal from the first added signal, and output the second added signal and the third added signal; a phase difference measurement unit configured to perform a phase difference measurement based on the second added signal and the third added signal; and an image pickup element drive unit configured to change a combination of photoelectric converters included in the second group so as to change a pupil division direction for the phase difference measurement performed in the phase difference measurement unit.

Further features of the present invention will become apparent from the following description of exemplary embodiments with reference to the attached drawings.

### BRIEF DESCRIPTION OF THE DRAWINGS

FIG. 1 is a block diagram for illustrating a configuration of an image processing apparatus according to a first embodiment of the present invention.

FIG. 2 is a schematic diagram of a pixel portion of an image pickup element according to the first embodiment.

FIG. 3 is a block diagram for illustrating a configuration of the image pickup element according to the first embodiment.

FIG. 4 is a diagram for illustrating a circuit configuration of the pixel portion of the image pickup element according to the first embodiment.

FIG. 5 is a drive timing chart of the image pickup element according to the first embodiment.

FIG. 6A and FIG. 6B are drive timing charts of the image pickup element in a horizontal blanking period according to the first embodiment.

FIG. 7 is an arrangement diagram of a focus detection area of the image pickup element according to the first embodiment.

FIG. 8A and FIG. 8B are block diagrams for illustrating a method of generating an output signal of an added signal separation unit according to the first embodiment.

FIG. 9 is a cross-sectional view of the pixel portion according to the first embodiment.

FIG. 10 is a graph for illustrating phase difference measurement processing according to the first embodiment.

FIG. 11 is a flowchart for illustrating an added signal separation program according to a second embodiment of the present invention.

### DESCRIPTION OF THE EMBODIMENTS

Preferred embodiments of the present invention will now be described in detail in accordance with the accompanying drawings. Like components are denoted by like reference symbols throughout the drawings, and descriptions of overlapping components are sometimes simplified or omitted.

### First Embodiment

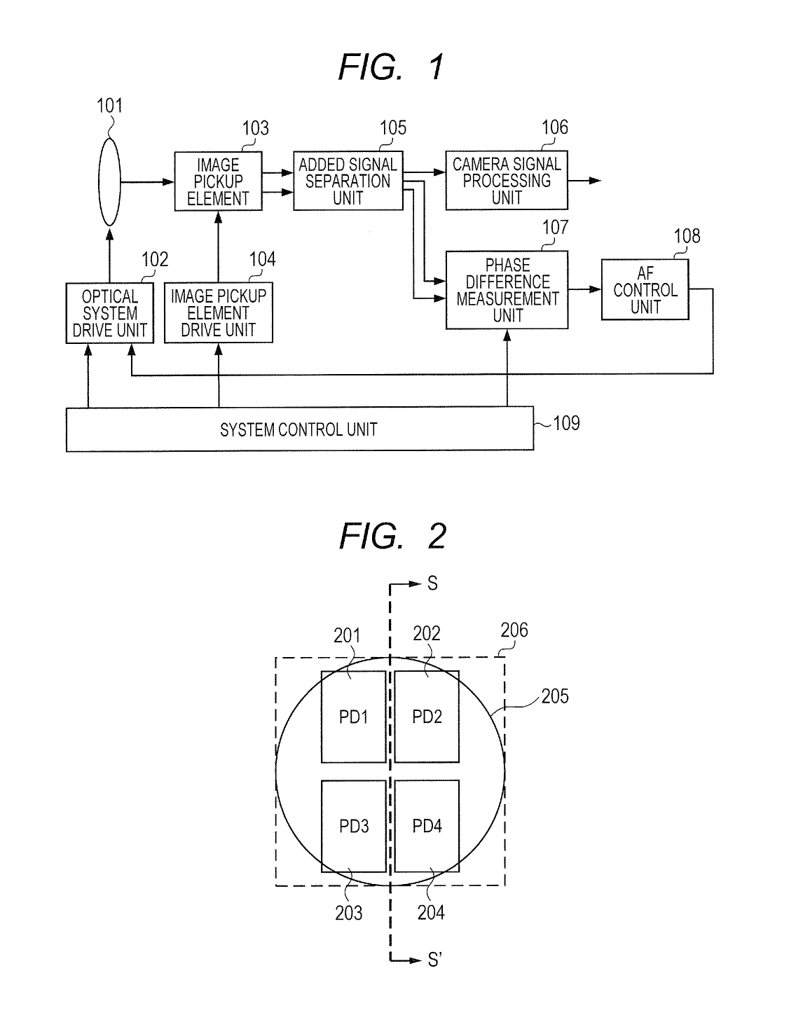

FIG. 1 is a block diagram for illustrating a configuration of an image processing apparatus according to a first embodiment of the present invention. The image processing apparatus includes an optical system 101, an optical system drive unit 102, an image pickup element 103, an image pickup element drive unit 104, an added signal separation unit 105, a camera signal processing unit 106, a phase difference measurement unit 107, an AF control unit 108, and a system control unit 109.

The optical system 101 is a part configured to guide incident light to the image pickup element 103, and includes at least one of a zoom lens, a diaphragm, and a focus lens. The optical system drive unit 102 is configured to control the optical system 101 based on focus information output from the AF control unit 108 and optical system drive information output from the system control unit 109.

The image pickup element 103 is configured to convert an object image entering the image pickup element 103 through the optical system 101 to an electrical signal by photoelectric conversion, and output two signals, namely, an image signal and a pupil-divided image signal, to the added signal separation unit 105. The image pickup element drive unit 104 is a drive apparatus configured to control the image pickup element 103 based on image pickup element drive instruction information from the system control unit 109. Note that, the image pickup element 103 may have an electronic shutter function. In that case, the image pickup element 103 may execute the electronic shutter function to achieve a desired exposure time in accordance with a control signal output from the image pickup element drive unit 104.

The added signal separation unit 105 is configured to subtract one pupil-divided image signal from the image signal output from the image pickup element 103 to generate the other pupil-divided image signal. The added signal separation unit 105 is configured to output the image signal to the camera signal processing unit 106 and output the generated two pupil-divided images to the phase difference measurement unit 107.

The camera signal processing unit 106 is configured to perform image processing on the image signal input from the added signal separation unit 105 and generate a video signal for display/record. The generated video signal is output to a display apparatus, a recording medium, and the like outside the image processing apparatus.

The phase difference measurement unit 107 is configured to calculate a phase difference estimated value for performing the phase difference measurement based on the two pupil-divided images obtained from the added signal separation unit 105, and output the phase difference estimated value to the AF control unit 108.

The AF control unit 108 is configured to calculate focus information for controlling a focus position of the optical system 101 based on the phase difference estimated value input from the phase difference measurement unit 107, and output the focus information to the optical system drive unit 102.

The system control unit 109 is a control apparatus configured to control the entire image processing apparatus. The system control unit 109 is configured to generate drive information for each unit of the image processing apparatus based on photographing information obtained through a user instruction, a photographing scene detection, an object detection, and the like. The system control unit 109 is configured to transmit drive information for the optical system 101, such as a zoom lens or diaphragm, to the optical system drive unit 102. Further, the system control unit 109 is configured to transmit drive information for the image pickup element 103, such as an instruction to switch the pupil division direction and an exposure time, to the image pickup element drive unit 104.

Next, a configuration of the image pickup element 103 and how the image pickup element 103 is driven according to this embodiment are described.

FIG. 2 is a schematic diagram for illustrating a structure of a pixel portion 206 in the image pickup element 103 according to this embodiment. The image pickup element 103 includes a plurality of the pixel portions 206 arranged in a matrix having rows and columns. The pixel portion 206 includes a plurality of photoelectric converters such as photodiodes (PD) configured to generate an electric charge corresponding to the incident light. In this embodiment, the pixel portion 206 having four photoelectric converters is exemplified.

The pixel portion 206 includes a photoelectric converter 201 (first photoelectric converter), a photoelectric converter 202 (second photoelectric converter), a photoelectric converter 203 (third photoelectric converter), and a photoelectric converter 204 (fourth photoelectric converter). The pixel portion 206 further includes a microlens 205, which is shared by the photoelectric converters 201, 202, 203, and 204. That is, light guided by the same microlens 205 enters the photoelectric converters 201, 202, 203, and 204. Other pixel portions arranged in the image pickup element 103 include similar photoelectric converters.

Signals obtained from the photoelectric converter 201, the photoelectric converter 202, the photoelectric converter 203, and the photoelectric converter 204 are referred to as A image, B image, C image, and D image, respectively. Adding signals output from the photoelectric converters 201, 202, 203, and 204 (first group) produces an image signal that is not pupil-divided. This image signal is referred to as A+B+C+D image (first added signal).

Further, adding signals obtained from the photoelectric converters 201 and 202 (second group), which are a part of the photoelectric converters 201, 202, 203, and 204 (first group), produces a signal (upper signal) from the photoelectric converters arranged on an upper side of the pixel portion 206. This is referred to as A+B image (second added signal). Adding signals obtained from the photoelectric converters 203 and 204 (third group) produces a signal (lower signal) from the photoelectric converters arranged on a lower side of the pixel portion 206. This is referred to as C+D image (third added signal). In this way, signals having vertically (first pupil division direction) divided pupils are obtained.

On the other hand, adding signals obtained from the photoelectric converters 201 and 203 (second group), which are a part of the photoelectric converters 201, 202, 203, and 204 (first group) chosen differently from the above-mentioned group, produces a signal (left signal) from the photoelectric converters arranged on a left side of the pixel portion 206. This is referred to as A+C image (second added signal). Adding signals obtained from the photoelectric converters 202 and 204 (third group) produces a signal (right signal) from the photoelectric converters arranged on a right side of the pixel portion 206. This is referred to as B+D image (third added signal). In this way, signals having horizontally (second pupil division direction) divided pupils are obtained.

As described above, it is possible to obtain signals having horizontally divided pupils or signals having vertically divided pupils by changing the addition target signals from respective photoelectric converters, which means that it is possible to change the pupil division direction. Further, it is also possible to obtain the image signal that is not pupil-divided.

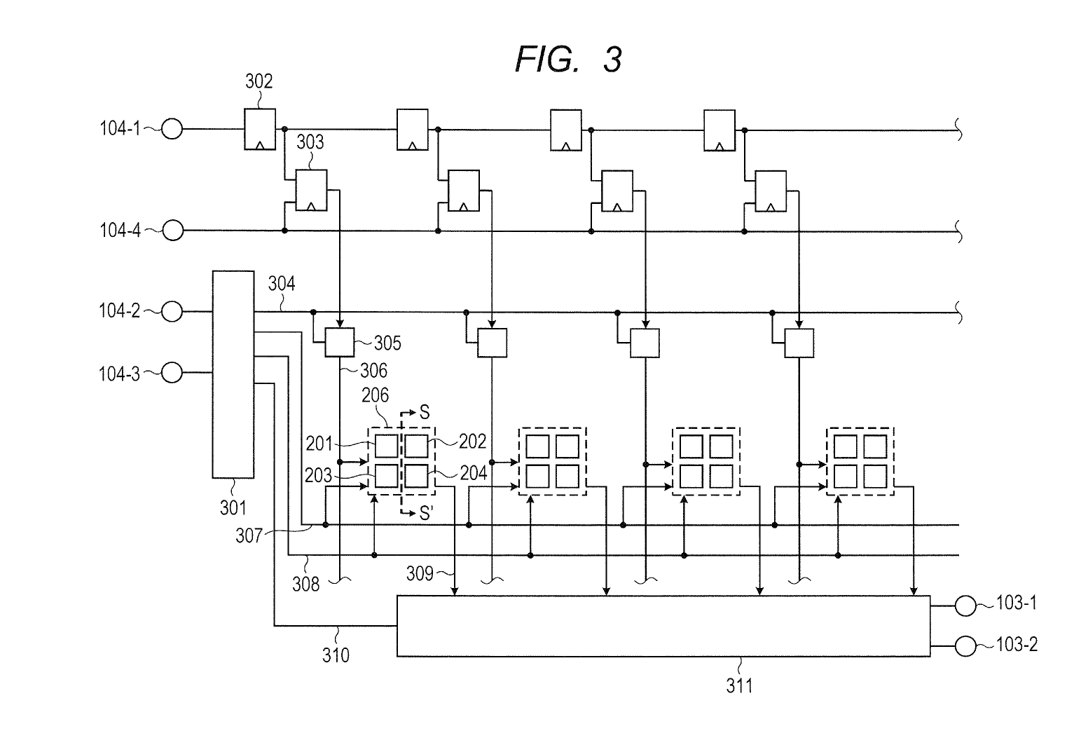

FIG. 3 is a block diagram for illustrating a configuration of the image pickup element 103 according to this embodiment. In FIG. 3, for the simplicity of description, only the structure having four pixel portions is illustrated. However, the number of rows and columns may be different from that illustrated, and an arbitrary number of rows and columns is conceivable.

The image pickup element 103 includes, as units for inputs from the image pickup element drive unit 104, a pupil division direction instruction input terminal 104-1, a horizontal synchronization signal input terminal 104-2, a vertical synchronization signal input terminal 104-3, and an instruction information update signal input terminal 104-4. Further, the image pickup element 103 includes, as units for outputs to the added signal separation unit 105, a first output terminal 103-1 and a second output terminal 103-2.

Pupil division direction instruction information is input to the pupil division direction instruction input terminal 104-1 from the image pickup element drive unit 104. A horizontal synchronization signal HD is input to the horizontal synchronization signal input terminal 104-2 from the image pickup element drive unit 104. A vertical synchronization signal VD is input to the vertical synchronization signal input terminal 104-3 from the image pickup element drive unit 104. An instruction information update signal is input to the instruction information update signal input terminal 104-4 from the image pickup element drive unit 104.

The image pickup element 103 includes a timing signal generation circuit 301, a first buffer 302, a second buffer 303, a transfer signal correction circuit 305, and a horizontal read-out circuit 311 as well as the above-mentioned pixel portion 206. Further, the image pickup element 103 includes a transfer signal common bus 304, a transfer signal line 306, a row read-out control signal line 307, a reset signal line 308, a column read-out signal line 309, and a horizontal drive control signal line 310. The first buffer 302, the second buffer 303, and the transfer signal correction circuit 305 are provided for each pixel column of the image pickup element 103.

The first buffer 302 is configured to hold the input pupil division direction instruction information, and output this information to the second buffer 303. The second buffer 303 is configured to update held information to the input pupil division direction instruction information at the timing that is based on the instruction information update signal, and output this updated information to the transfer signal correction circuit 305.

The horizontal synchronization signal HD and the vertical synchronization signal VD are input to the timing signal generation circuit 301. The timing signal generation circuit 301 is configured to output a control signal to the transfer signal common bus 304, the row read-out control signal line 307, the reset signal line 308, and the horizontal drive control signal line 310 at the timing that is based on the horizontal synchronization signal HD and the vertical synchronization signal VD.

The transfer signal correction circuit 305 is configured to correct a logical value of the transfer signal input from the transfer signal common bus 304 based on the pupil division direction instruction information, and output the corrected logical value to the transfer signal line 306 of each array. The transfer signal line 306 is formed of four transfer signal lines 306-1, 306-2, 306-3, and 306-4 corresponding to the photoelectric converters 201, 202, 203, and 204, respectively. Those transfer signal lines 306-1, 306-2, 306-3, and 306-4 are connected to the pixel portion 206.

The timing signal generation circuit 301 is configured to supply a row read-out control signal SEL to each pixel portion 206 via the row read-out control signal line 307. Further, the timing signal generation circuit 301 is configured to supply a reset signal RES to each pixel portion 206 via the reset signal line 308.

The pixel portion 206 is configured to output a signal from the photoelectric converters 201, 202, 203, and 204 to the column read-out signal line 309 based on those control signals. The signal output from the column read-out signal line 309 of each column is input to the horizontal read-out circuit 311. The horizontal read-out circuit 311 is configured to sequentially output, for each column, the signal from the column read-out signal line 309 to the first output terminal 103-1 and the second output terminal 103-2 based on a control signal input from the timing signal generation circuit 301 via the horizontal drive control signal line 310.

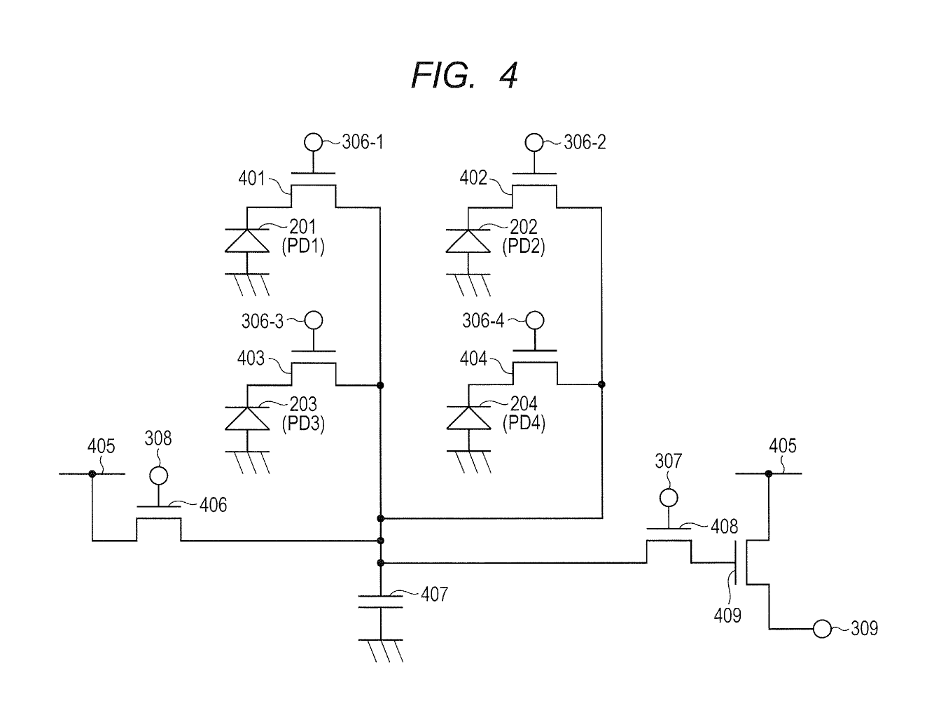

FIG. 4 is a diagram for illustrating a circuit configuration of the pixel portion of the image pickup element 103 according to the first embodiment of the present invention. The image pickup element 103 includes transfer transistors 401, 402, 403, and 404 respectively connected to the photoelectric converters 201, 202, 203, and 204. Electric charges generated in respective photoelectric converters 201, 202, 203, and 204 are transferred to a floating diffusion 407 via respective transfer transistors 401, 402, 403, and 404. The transfer transistors 401, 402, 403, and 404 are controlled to conduct electricity or not to conduct electricity based on transfer signals TX1, TX2, TX3, and TX4 input from the transfer signal lines 306-1, 306-2, 306-3, and 306-4, respectively.

The image pickup element 103 further includes a reset transistor 406, a row read-out transistor 408, and a source follower transistor 409. The reset transistor 406 is connected between a power line 405 and the floating diffusion 407. The row read-out transistor 408 is connected between the floating diffusion 407 and the gate node of the source follower transistor 409. The drain of the source follower transistor 409 is connected to the power line 405. The source of the source follower transistor 409 is connected to the column read-out signal line 309. The reset transistor 406 is controlled to conduct electricity or not to conduct electricity based on the reset signal RES input from the reset signal line 308. The row read-out transistor 408 is controlled to conduct electricity or not to conduct electricity based on the row read-out control signal SEL input from the row read-out control signal line 307.

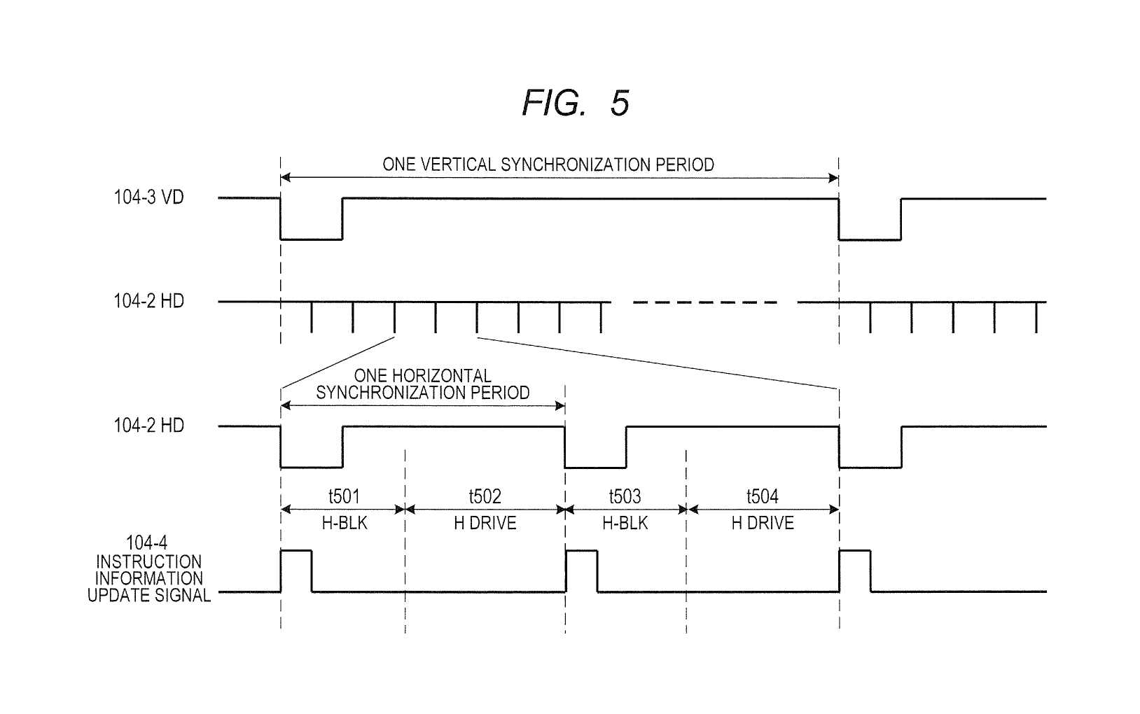

Now, an operation of the image pickup element drive unit 104 instructing the image pickup element 103 to divide the pupil and an operation of reading out a signal are described with reference to FIG. 3, FIG. 4, and FIG. 5.

FIG. 5 is a drive timing chart of the image pickup element 103. In FIG. 5, operation timings of the horizontal synchronization signal HD, the vertical synchronization signal VD, and the instruction information update signal are illustrated. One vertical synchronization period includes a plurality of horizontal synchronization periods. Each horizontal synchronization period is formed of a horizontal blanking period (H-BLK) and a horizontal drive period (H drive). The horizontal blanking period and the horizontal drive period of a horizontal synchronization period are represented by a period t501 and a period t502, respectively, and the horizontal blanking period and the horizontal drive period of the next horizontal synchronization period are represented by a period t503 and a period t504, respectively.

In the period t502, pupil division direction instruction information corresponding to a pixel row is input to the pupil division direction instruction input terminal 104-1. The pupil division direction instruction information is held in the first buffers 302 corresponding to respective pixel arrays. The pupil division direction instruction information held in the first buffers 302 is output to the second buffers 303. Note that, the pupil division direction instruction information is a digital signal having a logical value of 0 or 1. A signal having a value of 0 is a signal for instructing a pupil division in a vertical direction, and a signal having a value of 1 is a signal for instructing a pupil division in a horizontal direction.

Early in the period t503, values held in the second buffers 303 are updated to the values output from the first buffers 302 in response to an instruction information update signal input to the second buffers 303 from the instruction information update signal input terminal 104-4. As a result, the pupil division direction instruction information is input to the transfer signal correction circuits 305 from the second buffers 303.

A transfer signal from the transfer signal common bus 304 is input to the transfer signal correction circuits 305. The transfer signal correction circuit 305 corrects the transfer signal based on the pupil division direction instruction information such that the corrected transfer signal represents an operation corresponding to an instruction of the pupil division direction. Note that, the pupil division direction instruction information may allow the transfer signal from the transfer signal common bus 304 to pass as it is, and this operation is also included in “correction”.

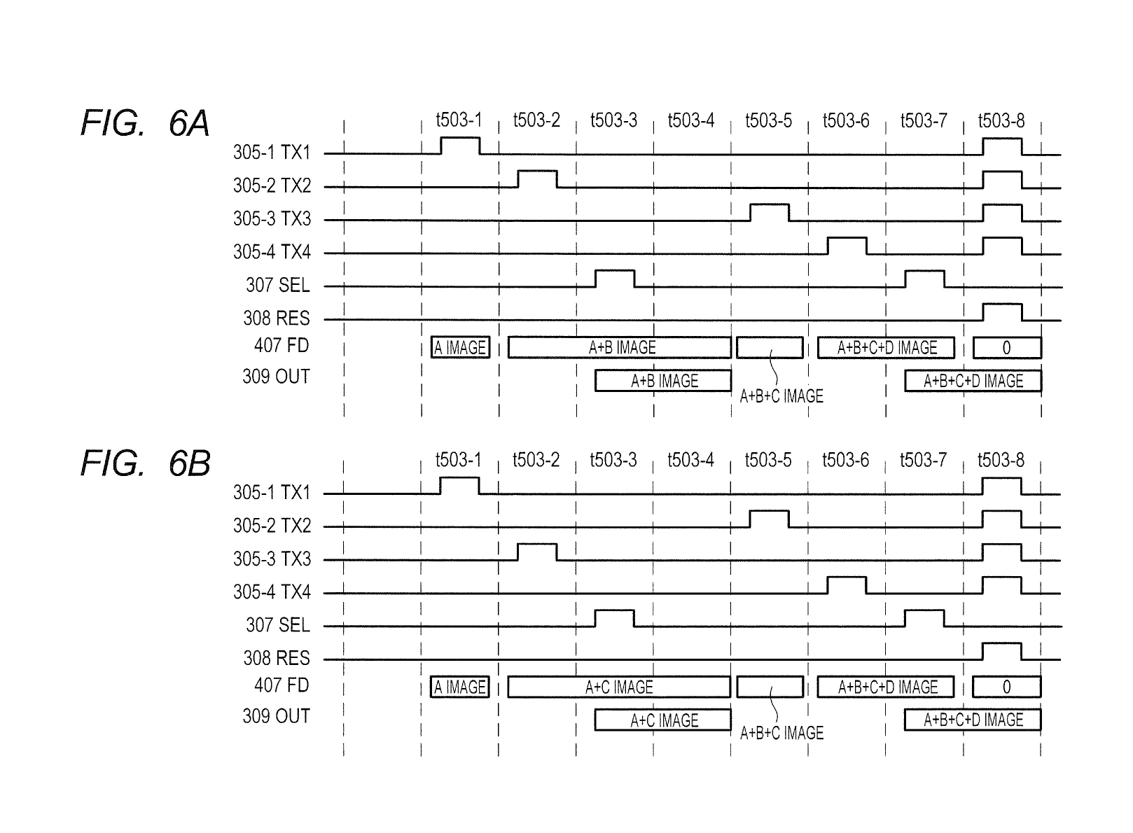

FIG. 6A and FIG. 6B are drive timing charts of the pixel portion 206 in the horizontal blanking period t503. FIG. 6A is a drive timing chart in the case where the value of the pupil division direction instruction information is 0 while FIG. 6B is a drive timing chart in the case where the value of the pupil division direction instruction information is 1. In FIG. 6A and FIG. 6B, the transfer signals TX1, TX2, TX3, and TX4, the row read-out control signal SEL, the reset signal RES, a signal accumulated in the floating diffusion (FD) 407, and a signal output from the column read-out signal line (OUT) 309 are illustrated.

A drive timing in the case where the value of the pupil division direction instruction information is 0 is described with reference to FIG. 6A. In a period t503-1, the transfer signal TX1 is set High. Because of this, the transfer transistor 401 conducts electricity, and the electric charge that corresponds to A image and is accumulated in the photoelectric converter 201 is transferred to the floating diffusion 407.

In a period t503-2, the transfer signal TX2 is set High. Because of this, the transfer transistor 402 conducts electricity, and the electric charge that corresponds to B image and is accumulated in the photoelectric converter 202 is transferred to the floating diffusion 407. Those electric charges are added in the floating diffusion 407 and the accumulated electric charge corresponds to A+B image.

In a period t503-3, the row read-out control signal SEL is set High. Because of this, the row read-out transistor 408 conducts electricity, and the voltage of the floating diffusion 407 is input to the gate node of the source follower transistor 409. A voltage signal corresponding to A+B image is output to the column read-out signal line 309.

In a period t503-5, the transfer signal TX3 is set High. Because of this, the transfer transistor 403 conducts electricity, and the electric charge that corresponds to C image and is accumulated in the photoelectric converter 203 is transferred to the floating diffusion 407. Those electric charges are added in the floating diffusion 407 and the accumulated electric charge corresponds to A+B+C image.

In a period t503-6, the transfer signal TX4 is set High. Because of this, the transfer transistor 404 conducts electricity, and the electric charge that corresponds to D image and is accumulated in the photoelectric converter 204 is transferred to the floating diffusion 407. Those electric charges are added in the floating diffusion 407 and the accumulated electric charge corresponds to A+B+C+D image.

In a period t503-7, the row read-out control signal SEL is set High in the same way as in the period t503-3, to thereby cause the voltage signal corresponding to A+B+C+D image to be output to the column read-out signal line 309.

In a period t503-8, the reset signal RES and all the transfer signals TX1, TX2, TX3, and TX4 are set High. Because of this, all the electric charges accumulated in the photoelectric converters 201, 202, 203, and 204 and the floating diffusion 407 are all reset to initial conditions. After that, photoelectric charges are accumulated in the photoelectric converters 201, 202, 203, and 204 in preparation for the next read-out drive.

In this way, when the value of the pupil division direction instruction information is 0, two signals, namely, the image signal that is not pupil-divided (A+B+C+D image) and the upper signal (A+B image), are read out from the image pickup element 103 and input to the horizontal read-out circuit 311.

In a horizontal drive period t504, the horizontal read-out circuit 311 outputs the upper signal (A+B image) from the first output terminal 103-1 and outputs the image signal that is not pupil-divided (A+B+C+D image) from the second output terminal 103-2.

Next, a drive timing in the case where the value of the pupil division direction instruction information is 1 is described with reference to FIG. 6B. The differences from FIG. 6A are operations in the period t503-2 and in the period t503-5. A description of an operation that is the same with that of FIG. 6A is omitted.

In the period t503-2, the transfer signal TX3 is set High. Because of this, the transfer transistor 403 conducts electricity, and the electric charge that corresponds to C image and is accumulated in the photoelectric converter 203 is transferred to the floating diffusion 407. Those electric charges are added in the floating diffusion 407 and the accumulated electric charge corresponds to A+C image. Thus, in the period t503-3, the voltage signal to be output to the column read-out signal line 309 corresponds to A+C image.

In the period t503-5, the transfer signal TX2 is set High. Because of this, the transfer transistor 402 conducts electricity, and the electric charge that corresponds to B image and is accumulated in the photoelectric converter 202 is transferred to the floating diffusion 407. Those electric charges are added in the floating diffusion 407 and the accumulated electric charge corresponds to A+B+C image. Thus, in the period t503-7, the voltage signal to be output to the column read-out signal line 309 corresponds to A+B+C+D image as in the case of the drive timing chart of FIG. 6A.

In this way, when the value of the pupil division direction instruction information is 1, two signals, namely, the image signal that is not pupil-divided (A+B+C+D image) and the left signal (A+C image), are read out from the image pickup element 103 and input to the horizontal read-out circuit 311. In the horizontal drive period t504, the horizontal read-out circuit 311 outputs the left signal (A+C image) from the first output terminal 103-1 and outputs the image signal that is not pupil-divided (A+B+C+D image) from the second output terminal 103-2. In this way, a combination of photoelectric converters provided to generate an added signal in order to generate the pupil-divided image is changed based on the value of the pupil division direction instruction information output from the image pickup element drive unit 104.

Note that, while only one pixel row is focused on in the above description of the drive timing, pupil division direction instruction information of the next row may be input in parallel in the same period. Further, the above-mentioned drive is sequentially performed for pixel rows forming the image pickup element 103 in one vertical synchronization period, and the accumulation and reading out of photoelectric charges are completed.

The image signals obtained from the image pickup element 103 are input to the added signal separation unit 105. The added signal separation unit 105 is configured to generate an image signal to be output to the camera signal processing unit 106 and a phase difference detection signal to be output to the phase difference measurement unit 107. The phase difference detection signal is a signal for detecting a phase difference that is obtained by subtracting the left signal (A+C image) or the upper image (A+B image), which is output from the first output terminal 103-1, from the image signal that is not pupil-divided (A+B+C+D image), which is output from the second output terminal 103-2.

The phase difference measurement unit 107 is configured to choose whether to perform a focus detection with use of the vertically pupil-divided image or perform a focus detection with use of the horizontally pupil-divided image based on the pupil division direction instruction information, and execute the phase difference measurement with use of the input phase difference detection signal.

The image signal that is not pupil-divided (A+B+C+D image) output from the added signal separation unit 105 is input to the camera signal processing unit 106. The camera signal processing unit 106 is configured to perform, on A+B+C+D image, image processing such as a color conversion, a white balance, and a gamma correction, resolution conversion processing, image compression processing, and the like to generate a video signal for display/record.

Note that, the pupil division direction instruction information may be set such that 0 and 1 switch in turn in units of one vertical synchronization period. With this, the horizontally (left and right) pupil-divided image and the vertically (upper and lower) pupil-divided image can be obtained alternately for each frame, thereby enabling an accurate phase difference measurement.

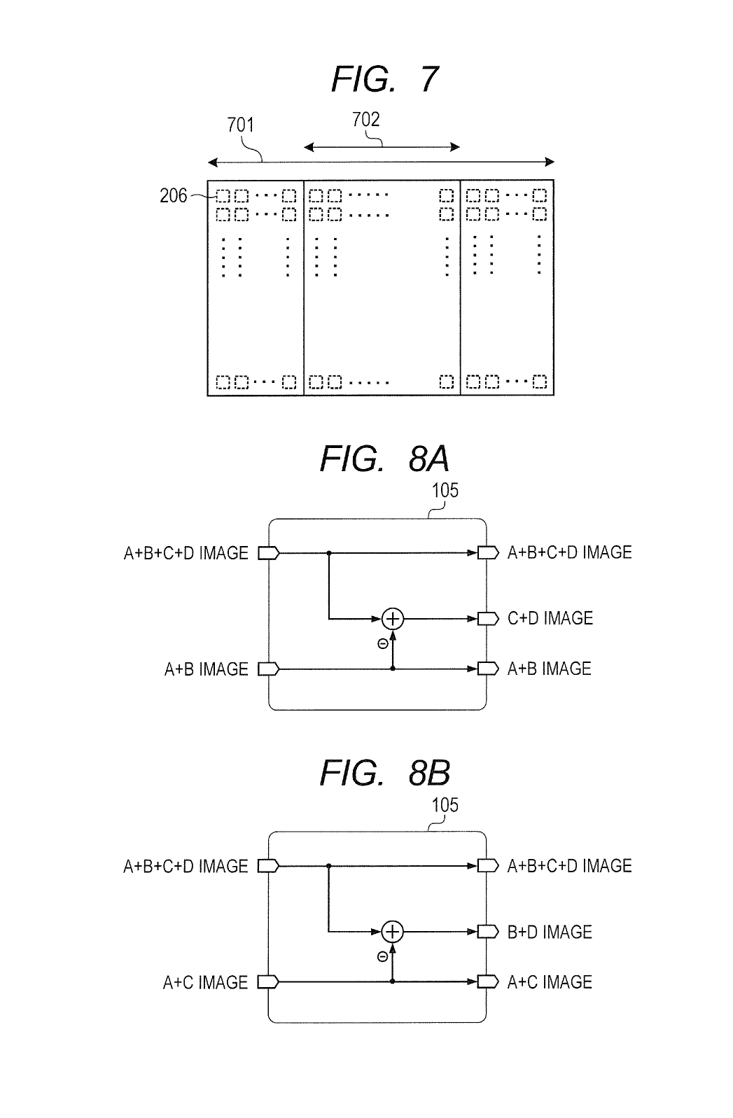

FIG. 7 is an arrangement diagram of a focus detection area of the image pickup element 103 according to the first embodiment. It is not necessary that the pixel portion 206 capable of obtaining the above-mentioned pupil-divided image for focus detection be arranged in all the areas of the image pickup element 103. A range indicated by an arrow 701 of FIG. 7 is an area for arranging effective pixels. In other words, the image signal that is not pupil-divided (A+B+C+D image) can be read out from this area of the pixel portion 206.

A range indicated by an arrow 702 of FIG. 7 is an area for arranging the pixel portions 206 capable of selectively reading out any one of the left signal (A+C image) and the upper signal (A+B image) as well as the image signal that is not pupil-divided (A+B+C+D image). In this way, it is possible to shorten the read-out time by obtaining the signal for focus detection only from a part of the image pickup element 103.

FIG. 8A and FIG. 8B are block diagrams for illustrating a method of generating an output signal of the added signal separation unit 105 according to the first embodiment. FIG. 8A is an illustration of processing in the case where the value of the pupil division direction instruction information is 0 while FIG. 8B is an illustration of processing in the case where the value of the pupil division direction instruction information is 1.

In FIG. 8A, the signals input to the added signal separation unit 105 are A+B+C+D image and A+B image as described above. The added signal separation unit 105 subtracts A+B image from A+B+C+D image to generate C+D image. Further, in addition to this, the added signal separation unit 105 outputs A+B+C+D image and A+B image as it is. Thus, the added signal separation unit 105 outputs three images, namely, A+B+C+D image, A+B image, and C+D image. In this way, the vertically pupil-divided images and the image signal that is not pupil-divided are output.

In FIG. 8B, the signals input to the added signal separation unit 105 are A+B+C+D image and A+C image as described above. The added signal separation unit 105 subtracts A+C image from A+B+C+D image to generate B+D image. Further, in addition to this, the added signal separation unit 105 outputs A+B+C+D image and A+C image as it is. Thus, the added signal separation unit 105 outputs three images, namely, A+B+C+D image, A+C image, and B+D image. In this way, the horizontally pupil-divided images and the image signal that is not pupil-divided are output.

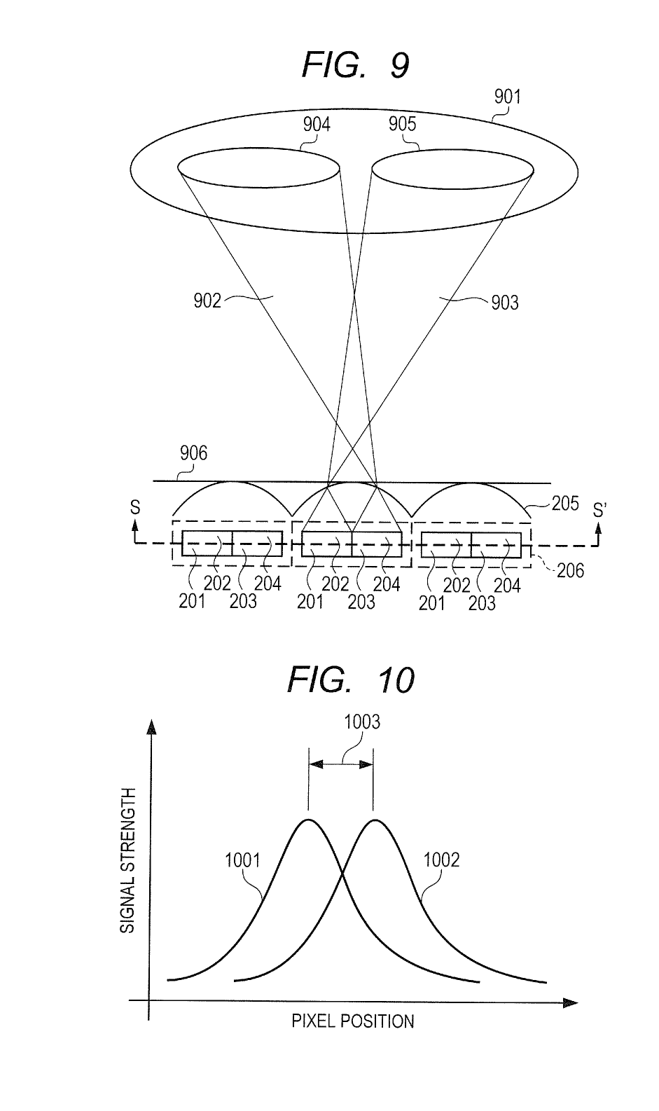

Next, a method of calculating a phase difference estimated value with use of the pupil-divided image, which is performed in the phase difference measurement unit 107, is described with reference to FIG. 9 and FIG. 10.

FIG. 9 is a diagram for schematically illustrating a cross-section of the pixel portion 206 illustrated in FIG. 2 taken along the line S-S′. In FIG. 9, a positional relationship between the pixel portion 206 and an exit pupil is illustrated. The photoelectric converters 201 and 202 are arranged on the left side of the pixel portion 206 while the photoelectric converters 203 and 204 are arranged on the right side of the pixel portion 206. The microlens 205 shared by those photoelectric converters is arranged above the photoelectric converters 201, 202, 203, and 204. The top portions of the microlenses 205 form an image formation plane 906 of an image pickup lens (not illustrated) at the time of in-focus.

Further, in FIG. 9, exit pupils 901, 904, and 905 are illustrated. The exit pupil 901 is an exit pupil of an image pickup lens when seen from the pixel portion 206 side. The exit pupil 904 is an exit pupil of the photoelectric converters 203 and 204 that is projected onto an exit pupil position by the microlens 205. The exit pupil 905 is an exit pupil of the photoelectric converters 201 and 202 that is similarly projected onto an exit pupil position. The distance from the image formation plane 906 of the image pickup lens at the time of in-focus to the exit pupil 901 is referred to as an exit pupil position. The exit pupil position changes depending on the curvature of a lens group located behind (image formation plane side) a lens diaphragm (not illustrated) and a positional relationship with respect to the diaphragm. Further, the size of the exit pupil changes depending on the radius of the diaphragm. A light flux 903 passing through the exit pupil 905 is designed to enter the photoelectric converters 201 and 202, and a light flux 902 passing through the exit pupil 904 is designed to enter the photoelectric converters 203 and 204.

In this way, an image seen in an area of the exit pupil 905 on the right side of the exit pupil 901 of the image pickup lens is obtained in the photoelectric converters 201 and 202 located on the left side of the pixel portion 206. Similarly, an image seen in an area of the exit pupil 904 on the left side of the exit pupil 901 of the image pickup lens is obtained in the photoelectric converters 203 and 204. Note that, other pixel portions 206 forming the image pickup element 103 (not illustrated) have similar optical designs.

Assuming that the image obtained on the image pickup element 103 through the light flux 902 is C+D image and the image obtained on the image pickup element 103 through the light flux 903 is A+B image, the difference between A+B image and C+D image corresponds to a parallax between the light flux 902 and the light flux 903.

FIG. 10 is a graph for illustrating the phase difference measurement. In FIG. 10, an image signal 1001 (A+B image) and an image signal 1002 (C+D image) are illustrated under a front-focus state, that is, a state in which the focus is in a nearer side than the object. The vertical axis represents a signal strength and the horizontal axis represents a position of a pixel in the S-S′ line direction. The information on a distance to the object based on the phase difference detection method is calculated based on a distance 1003 between images obtained by the image signal 1001 and the image signal 1002 and on a distance from the image forming plane at the focus position to the exit pupil. The phase difference measurement unit 107 outputs, as a phase difference estimated value, the calculated information on the distance to the object to the AF control unit 108.

The AF control unit 108 determines a target focus position based on the phase difference estimated value output from the phase difference measurement unit 107, and outputs a movement direction and a movement amount from the current focus position to the optical system drive unit 102 as focus information. The optical system drive unit 102 drives the optical system 101 based on the focus information and adjusts the focus position.

Note that, in the above description of the phase difference measurement, the phase difference measurement is exemplified by using image signals (upper signal and lower signal) that are vertically pupil-divided and read out. However, the phase difference measurement can similarly be achieved by using image signals (left signal and right signal) that are horizontally pupil-divided and read out.

In this embodiment, there is provided an image pickup apparatus capable of measuring a phase difference, which is configured to be capable of suppressing the increase in number of signals to be read out even when there are a large number of photoelectric converters, and allowing the pupil division direction to be switched.

### Second Embodiment

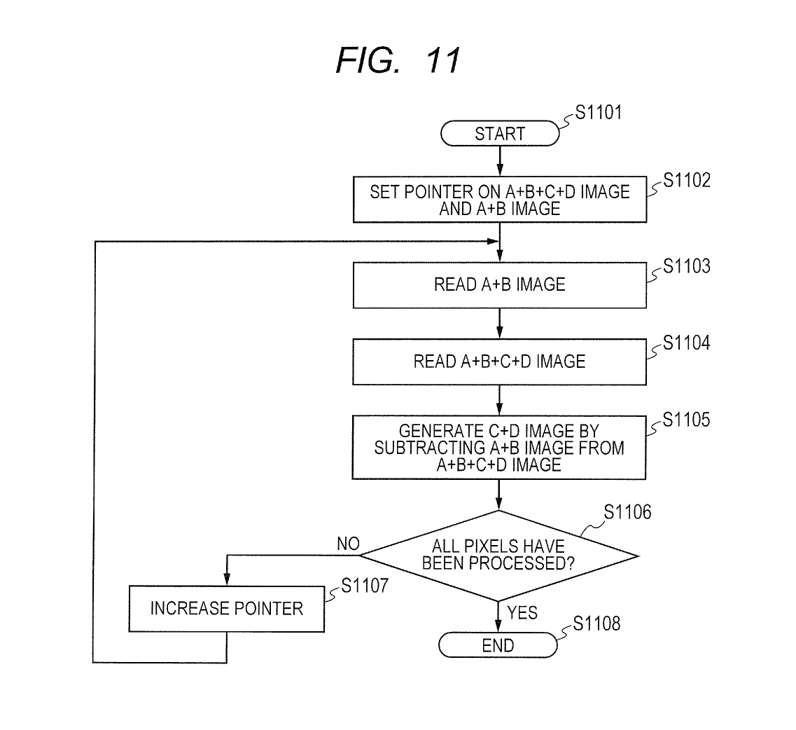

An image processing method according to a second embodiment of the present invention is described with reference to the flowchart of FIG. 11.

In the second embodiment, a configuration for carrying out generation of the pupil-divided image by a computer is described. In other words, this embodiment is directed to realizing generation of the pupil-divided image in the added signal separation unit 105 in the first embodiment with use of a computer. The same configuration as that of the first embodiment may be employed for other components forming the image processing apparatus.

The computer to be used for image processing in this embodiment includes a CPU for performing calculations, a memory for storing an output from the image pickup element 103 and for storing a program, and the like. The computer realizes the generation of the pupil-divided image by executing a program stored in the memory. In this embodiment, an output from the image pickup element 103 (image signal that is not pupil-divided and pupil-divided signal) described in the first embodiment is temporarily stored in the memory, and this output data is used to perform processing.

FIG. 11 is a flowchart for illustrating a program for generating C+D image based on A+B+C+D image and A+B image, which are stored in the memory of the computer.

In Step S1101, the generation of the pupil-divided image is started. In Step S1102, the computer sets a pointer to secure a memory area for storing A+B+C+D image, A+B image, and C+D image, and initializes this memory area.

In Step S1103, the computer reads A+B image and stores this image in the memory area of A+B image. In Step S1104, the computer reads A+B+C+D image and stores this image in the memory area of A+B+C+D image.

In Step S1105, the computer subtracts A+B image from A+B+C+D image to generate C+D image, and stores this image in the memory area of C+D image.

In Step S1106, the computer determines whether or not all the pixels have been processed. When not all the pixels have been processed, the processing proceeds to Step S1107. In Step S1107, the computer increases the pointer and the processing returns to Step S1103. Thus, the same processing is repeatedly executed for the next pixel data.

When the computer determines that all the pixels have been processed in Step S1106, the processing proceeds to Step S1108 and ends.

In accordance with the above-mentioned flow, C+D image is generated with use of A+B+C+D image and A+B image in the same way as in the first embodiment. Note that, in this embodiment, the same configuration as that of the first embodiment may be employed for configurations other than the generation of the pupil-divided image.

As described above, it is possible to realize the generation of the pupil-divided image with use of the computer easily as well as to obtain the same effect as that of the first embodiment also in this embodiment.

Note that, in the flowchart of FIG. 11, the upper signal (A+B image) is stored in the memory, and this signal is used to generate the lower signal (C+D image). However, a configuration may be employed in which the left signal (A+C image) is stored in the memory and used to generate the right signal (B+D image). The same processing may be employed also in this case.

### Other Embodiments

Four photoelectric converters 201, 202, 203, and 204 share one microlens 205 in the first and second embodiments. However, the number of photoelectric converters may be five or more.

The value of the pupil division direction instruction information may be switched to 0 or 1 in units of pixel row or pixel column. In this case, the horizontally (left and right) pupil-divided image and the vertically (upper and lower) pupil-divided image can be obtained alternatively for each row or for each column, and it is possible to achieve an accurate phase difference measurement using both the phase difference in the horizontal direction and the phase difference in the vertical direction.

The pupil division direction instruction information may be configured to take the value of 1 as an initial value to indicate that the pupil division is performed horizontally (left and right) in normal conditions, and change the value to 0 only when a predetermined condition is satisfied. For example, the pupil division direction instruction information may be configured to change the value to 0 to indicate that the pupil division is performed vertically (upper and lower) only when, for example, the accuracy of the phase difference measurement is equal to or less than a predetermined value in the horizontal (left and right) pupil division. With this, it is possible to achieve the phase difference measurement appropriate to the photographing situation. Note that, the pupil division direction instruction information may be configured to take the value of 0 as an initial value to indicate that the pupil division is performed vertically (upper and lower) in normal conditions, and change the value to 1 to indicate that the pupil division is performed horizontally (left and right) only when the accuracy of the phase difference measurement is equal to or less than a predetermined value.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-021317, filed Feb. 5, 2015, which is hereby incorporated by reference herein in its entirety.

What is claimed is:

1. An image processing apparatus, comprising:
an image pickup element comprising pixel portions, the pixel portions each comprising a plurality of photoelectric converters and each being configured to output a first added signal obtained by adding signals output from a first group among the plurality of photoelectric converters and output a second added signal obtained by adding signals output from a second group, which is a part of the first group among the plurality of photoelectric converters;
an added signal separation unit configured to generate a third added signal by subtracting the second added signal from the first added signal, and output the second added signal and the third added signal;
a phase difference measurement unit configured to perform a phase difference measurement based on the second added signal and the third added signal; and
an image pickup element drive unit configured to be capable of changing a combination of photoelectric converters included in the second group so as to change a pupil division direction for the phase difference measurement performed in the phase difference measurement unit.

2. The image processing apparatus according to claim 1, wherein the plurality of photoelectric converters included in the first group are configured to output a signal that is based on light guided by a single microlens.

3. The image processing apparatus according to claim 1,
wherein the first group comprises a first photoelectric converter, a second photoelectric converter, a third photoelectric converter, and a fourth photoelectric converter, and
wherein when the image pickup element drive unit selects a first pupil division direction, the second group comprises the first photoelectric converter and the second photoelectric converter, and when the image pickup element drive unit selects a second pupil division direction, the second group comprises the first photoelectric converter and the third photoelectric converter.

4. The image processing apparatus according to claim 3, wherein the image pickup element drive unit is configured to switch between the first pupil division direction and the second pupil division direction for each image pickup frame.

5. The image processing apparatus according to claim 3,
wherein the pixel portions of the image pickup element are arranged in a matrix having rows and columns, and
wherein the image pickup element drive unit is configured to switch between the first pupil division direction and the second pupil division direction for one of each column of the pixel portions and each row of the pixel portions.

6. The image processing apparatus according to claim 3, wherein the image pickup element drive unit is configured to switch the pupil division direction when an accuracy of the phase difference measurement is equal to or less than a predetermined value under a normal condition, the normal condition being defined to be any one of the first pupil division direction and the second pupil division direction.

7. An image processing method, comprising:
inputting a first added signal obtained by adding signals output from a first group among a plurality of photoelectric converters included in each of pixel portions of an image pickup element, and a second added signal obtained by adding signals output from a second group, which is a part of the first group among the plurality of photoelectric converters;
generating a third added signal by subtracting the second added signal from the first added signal; and
outputting the second added signal and the third added signal,
wherein the second added signal and the third added signal are used for a phase difference measurement, and
wherein a combination of photoelectric converters included in the second group is allowed to be changed so as to change a pupil division direction for the phase difference measurement.

8. A non-transitory computer-readable storage medium having stored thereon a program for causing a computer to execute an image processing method, the image processing method comprising:
inputting a first added signal obtained by adding signals output from a first group among a plurality of photoelectric converters included in each of pixel portions of an image pickup element, and a second added signal obtained by adding signals output from a second group, which is a part of the first group among the plurality of photoelectric converters;
generating a third added signal by subtracting the second added signal from the first added signal; and
outputting the second added signal and the third added signal,
wherein the second added signal and the third added signal are used for a phase difference measurement, and
wherein a combination of photoelectric converters included in the second group is allowed to be changed so as to change a pupil division direction for the phase difference measurement.
